(19) United States
(12) Patent Application Publication
(10) Pub. No.: US 2014/0215501 A1
(43) Pub. Date: Jul. 31, 2014

(54) DISC CLAMPING STRUCTURE OF OPTICAL DISC DRIVE

(71) Applicant: LITE-ON IT CORPORATION, Taipei (TW)

(72) Inventors: Chia-Jen LIN, Hsinchu (TW); Chun-Lung HO, Hsinchu (TW); Jung-Fang CHANG, Hsinchu (TW); Shih-Lin YEH, Hsinchu (TW)

(73) Assignee: LITE-ON IT CORPORATION, Taipei (TW)

(21) Appl. No.: 14/166,204

(22) Filed: Jan. 28, 2014

(30) Foreign Application Priority Data
Jan. 30, 2013 (CN) 201310035965.X

(51) Int. Cl. G11B 17/028

(52) U.S. Cl. CPC G11B 17/0284
USPC 720/708

(57) ABSTRACT

A disc clamping structure is provided. A fixing base is disposed on a turntable. A plurality of ball seats are disposed around a periphery of the fixing base, and each of the ball seats has an aperture. The balls are received in the ball seats. The elastic members are disposed within the fixing base. The balls are upwardly moved, and the height of the center point of the ball is adjusted according to the thickness of the disc when the disc is clamped on the turntable. A portion of the ball is projected from the aperture of the ball seat before clamping the disc.

This application claims the benefit of People's Republic of China application Serial No. 201310035965.X, filed Jan. 30, 2013, the subject matter of which is incorporated herein by reference.

### BACKGROUND OF THE INVENTION

1. Field of the Invention

The invention relates in general to a clamping structure, and more particularly to a disc clamping structure of an optical disc drive.

2. Description of the Related Art

Along with the popularity of information, people are used to view films or listen to music by using a disc drive to read data from an optical disc. Due to the features of large capacity, convenient portability and data storage, optical disc has become one of most commonly used storage media.

In general, the disc is engaged with a magnetic turntable by a clamper. Then, the turntable is rotated by a spindle motor. Therefore, even when the disc is rotated at a high speed, the disc will not wobble or tilt to prevent the disc drive incapable of reading data from the disc. However, the mechanism of clamping the disc by a magnetic force requires to configure a magnetic material in the clamper and the turntable, hence incurring higher cost. Furthermore, since under the circumstance that an interior space of the disc drive is limited, and the arrangement of the clamper requires extra parts, the overall thickness and weight of the disc drive would be increased accordingly.

### SUMMARY OF THE INVENTION

The invention is directed to a disc clamping structure applied on a turntable for clamping the disc on the turntable.

According to one aspect of the present invention, a disc clamping structure comprising a fixing base disposed on the turntable; a plurality of ball seats disposed around a periphery of the fixing base, each of the ball seats having an aperture; a plurality of balls respectively received in corresponding one of the ball seats; and a plurality of elastic members disposed within the fixing base, wherein the elastic members respectively push corresponding one of the balls for leaning the balls on the apertures; wherein, the balls are upwardly moved, and the height of the center point of the ball is adjusted according to the thickness of the disc when the disc is clamped on the turntable; wherein, a portion of the ball is projected from the aperture of the ball seat before clamping the disc.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A and 1B are schematic diagrams illustrating a clamping movement of a disc according to an embodiment of the invention.

FIGS. 2A and 2B are decomposition diagram of a disc clamping structure and a bottom diagram of an assembly of the disc clamping structure according to an embodiment of the invention, respectively.

FIGS. 3A˜3C are schematic diagrams illustrating a movement of a disc clamping structure according to an embodiment of the invention.

FIGS. 4A and 4B are schematic diagrams illustrating the height of the ball being adjusted along with thickness of the disc.

FIG. 4C is a comparison diagram without an upper opening.

FIGS. 5A˜5C are schematic diagrams illustrating a disc being shifted and calibrated.

FIGS. 6A and 6B are a 3D diagram of a disc clamping structure and a partial cross-sectional diagram of the interior of the disc clamping structure according to a second embodiment of the invention, respectively.

FIG. 6C is a cross-sectional diagram illustrating a ball seat and a fixing base in FIG. 6B facing towards each other by two protrusions.

### DETAILED DESCRIPTION OF THE INVENTION

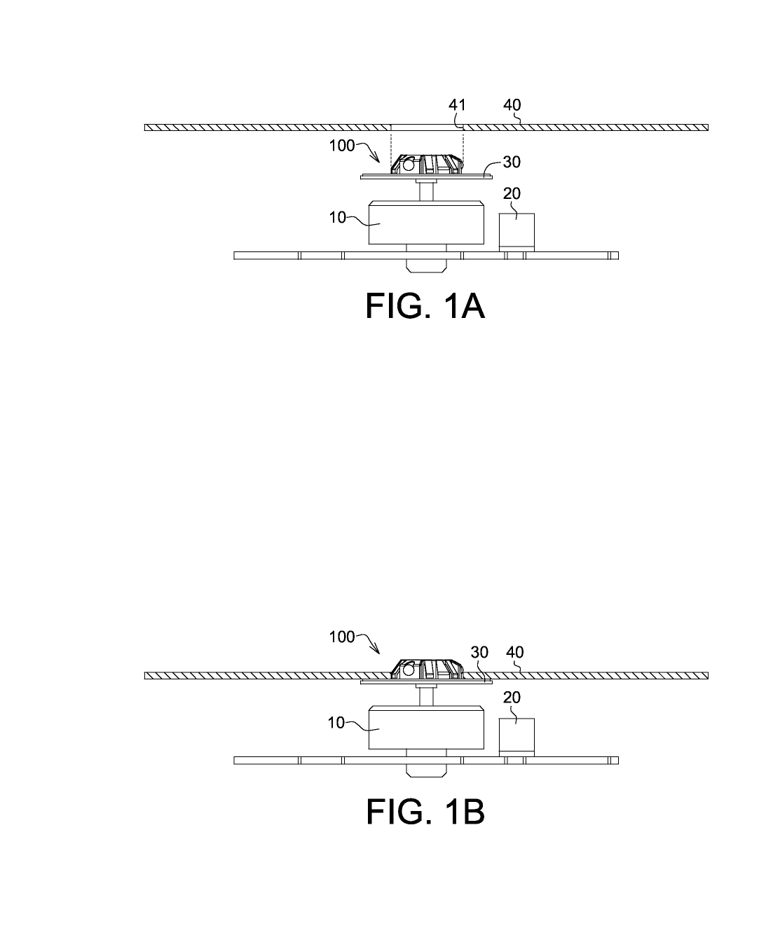

Referring to FIGS. 1A and 1B, schematic diagrams illustrating a clamping movement of a disc according to an embodiment of the invention are shown. Let a disc drive be taken for example. The disc drive has a spindle motor 10 and a pickup unit 20. The spindle motor 10 provides a rotation power to a turntable 30. The disc clamping structure 100 is disposed on the turntable 30 for clamping a disc 40. As indicated in FIG. 1A, when the disc 40 is loaded in the disc drive, the center of the disc 40 is aligned with the center of the turntable 30. As indicated in FIG. 1B, the disc 40 is mounted on the disc clamping structure 100, and the turntable 30 is driven by the spindle motor 10, so that the disc 40 is rotated along with the turntable 30 for the pickup unit 20 to read data from the disc 40. After finishing the data reading, the disc 40 is released from the disc clamping structure 100 and unloaded from the disc drive.

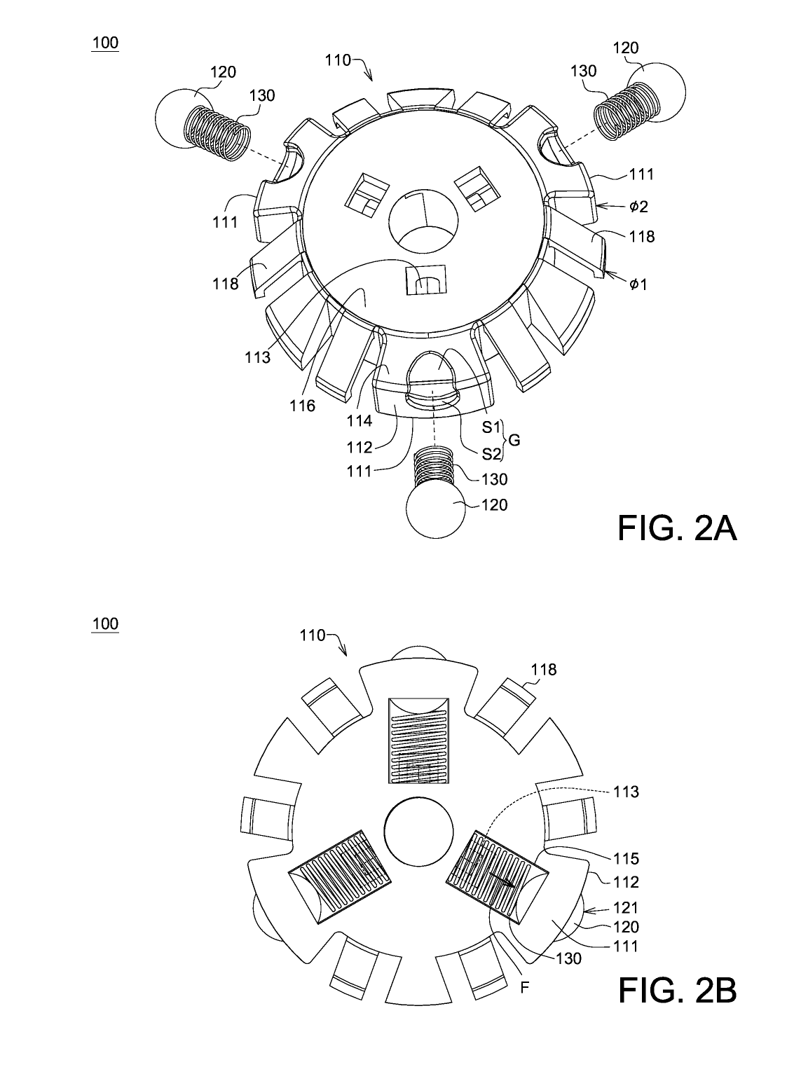

Referring to FIGS. 2A and 2B, a decomposition diagram of a disc clamping structure 100 and a bottom diagram of an assembly of the disc clamping structure 100 according to an embodiment of the invention are respectively shown. The disc clamping structure 100 comprises a fixing base 110, several balls 120 and several elastic members 130 corresponding to the balls 120. The fixing base 110 has a plurality of ball seats 111 disposed on a periphery of the fixing base 110, and the ball seats 111 are used for receiving corresponding balls 120. Each of ball seats 111 has an aperture G on the corresponding sidewalls 112 of the ball seats 111, and a lateral size of the aperture G is slightly smaller than the diameter of the ball 120, so that only a portion of an outer surface 121 of the ball 120 is exposed to the outside of the ball seats 111 through the recess G.

The aperture G in the above embodiment is gourd-shaped, and has an upper opening S1 and a lower opening S2. Each ball seat 111 has a camber 114 set with respect to the upper opening S1. The cambers 114 are upwardly extended to a platform 116 to form a conical dome.

Besides, on the periphery of the fixing base 110 there are several elastic jaws 118 arranged in a circular shape and disposed on the outer peripheral surfaces of the fixing base 110 between two adjacent ball seats 111. The outer diameter φ1 of the elastic jaw 118 is slightly larger than the outer diameter φ2 of the sidewall 112 of ball seat 111, so that when a disc 40 is mounted on the fixing base 110, the elastic jaws 118 are contracted inwardly to generate an elastic force preloaded on the inner hole wall 41 of the disc 40 of FIG. 1A.

Referring to FIG. 2B, the fixing base 110 has several grooves 115 radially disposed therein (for example, an Y-shaped arrangement or other types of arrangement) and extended to the sidewalls 112 of the ball seats 111, so that the terminal ends of the grooves 115 are interconnected with corresponding apertures G. The quantity of grooves 115 is exemplified by 3 or more than 3 in the above embodiment but the invention is not limited thereto. The grooves 115 are separated by an equal interval and are disposed at an angle of 120 degrees or other degrees. Both the quantity of grooves 115 and the angle formed between the grooves 115 in the above embodiment are not limited.

As indicated in FIG. 2B, elastic members 130 are movably disposed within a corresponding groove 115 of the fixing base 110, one end of the elastic members 130 is mounted on a corresponding fixing column 113, the other end of the elastic members 130 is movably connected to a corresponding ball 120 and pushes the corresponding ball 120 with a horizontal force F for moving the corresponding ball 120 outwardly along the direction of the horizontal force F, so that each ball 120 is preloaded to lean on a corresponding aperture G by the elastic member 130.

In addition, each ball seat 111 has an accommodation space similar to a ball socket for receiving a corresponding ball 120, and a portion of outer surface 121 of the ball 120 is projected from the sidewall 112 of the ball seat 111 through an upper opening S1 and a lower opening S2 of the aperture G as indicated in FIG. 2B to increase flexible space allowing the movement of the ball 120.

Through the design of the upper opening S1 and the lower opening S2, when a portion of outer surface 121 of each ball 120 is projected from the sidewall 112 of the ball seat 111, each ball 120 can generate a shift between the upper opening S1 and the lower opening S2 of the aperture G according to a thickness of the disc 40 so as to adjust the height of the balls 120 in corresponding ball seats 111. Detailed descriptions of the above design through various embodiments are disclosed below.

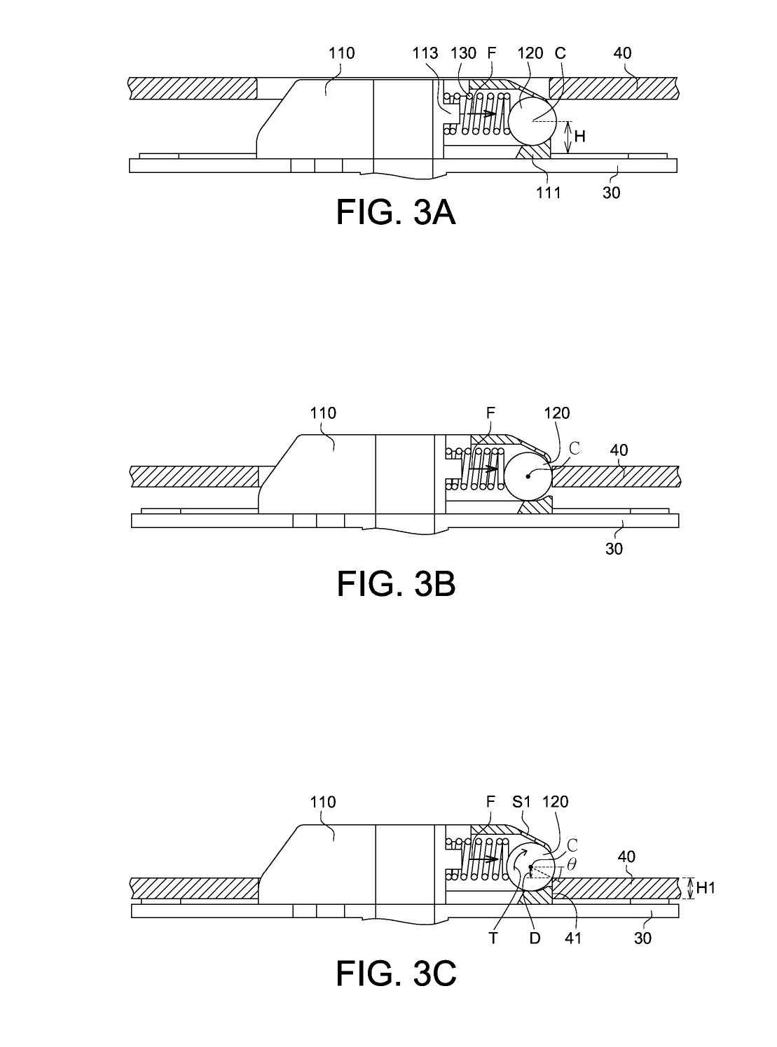

Referring to FIGS. 3A˜3C, schematic diagrams illustrating a movement of a disc clamping structure 100 according to an embodiment of the invention are shown. As indicated in FIG. 3A, before a disc 40 is mounted on the fixing base 110, the ball 120 is leaned on the aperture G by a horizontal force F provided by the elastic member 130. Meanwhile, the ball 120 is supported by a ball seat 111, so that the central point C of the ball 120 is at a default height H. As indicated in FIG. 3B, when the ball 120 contacts the inner hole wall 41 of the disc 40, the ball 120 is contracted inwardly to reduce the reaction force generated by the disc 40 when the disc 40 passes through the ball 120. As indicated in FIG. 3C, after the disc 40 passes through the ball 120 and placed on the turntable 30, the ball 120 is bounced back and shifted upwardly for a distance, so that the ball 120 contacts an upper edge of the inner hole wall 41 of the disc 40 for firmly clamping the disc 40 on the turntable 30.

As indicated in FIG. 3C, the disc 40 has a first thickness H1 such as 1.1 mm, and the ball 120 contacts the upper edge of the inner hole wall 41 of the disc 40 at a contact angle θ. The contact angle θ is defined as an angle formed by a horizontal line and a connection line connecting the central point C of the ball 120 to the upper edge of the inner hole wall 41 of the disc 40. The larger the contact angle θ, the larger the clamping force applied on the disc 40 by the ball 120, the more unlikely will the disc 40 be released from the clamping of the ball 120 when the disc 40 is rotated at a high speed.

During the process of clamping the disc 40, the upper opening S1 disposed above the ball 120 creates extra vertical space for allowing the ball 120 to move upwardly and makes the central point C of the ball 120 relatively shifted upwardly. Due to the height difference D between the central point C of the ball 120 and the upper edge of the inner hole wall 41 of the disc 40, the horizontal force F passing through the central point C of the ball 120 provides a torque T with respect to the ball 120 for moving the ball 120 upwardly and clamping the disc 40 downwardly.

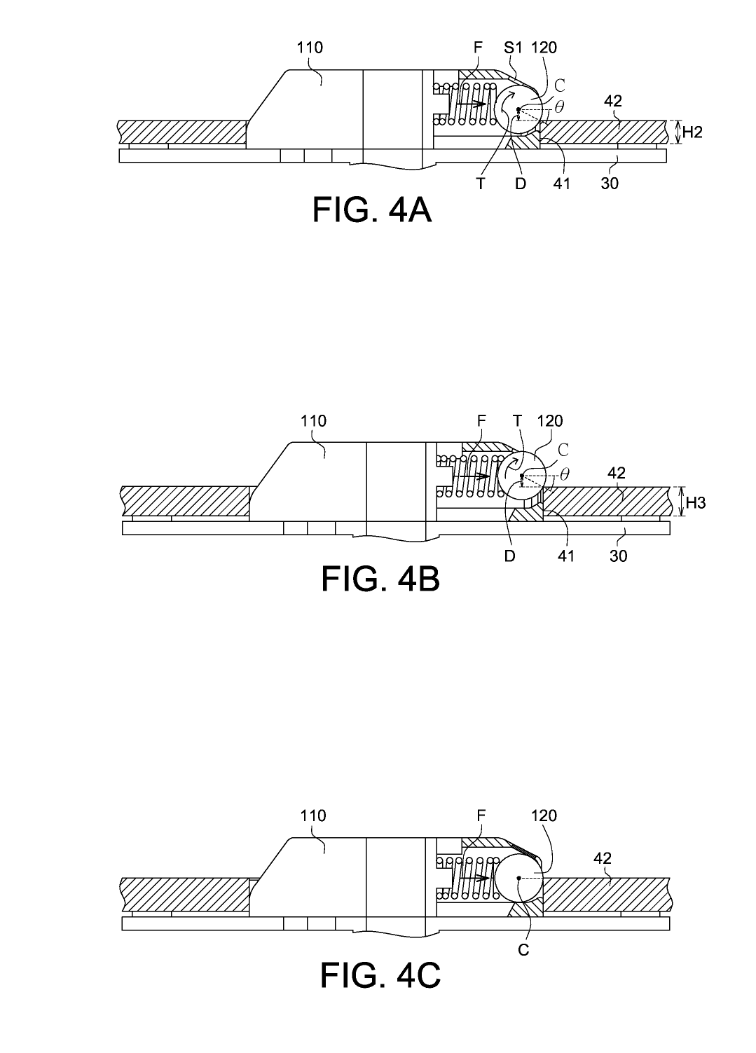

Particularly, when the thickness of the disc 40 is increased in the above embodiment, the contact angle θ between the ball 120 and the disc 40 will not decrease accordingly, and will still maintain at a fixed value. Referring to FIGS. 4A and 4B, schematic diagrams illustrating the height of the ball 120 being adjusted along with thickness of the disc 42 are shown. When the disc 42 mounted on the fixing base 110 has a second thickness H2 or a third thickness H3, such as 1.2 mm or 1.5 mm, the ball 120 contacts the upper edge of the inner hole wall 41 of the disc 42. However, the contact angle still remains at θ and will not decrease as the thickness of the disc 42 increases. This is mainly because when the ball 120 contacts the disc 42 having different height levels, the upper opening S1 disposed above the ball 120 creates extra vertical space for allowing the ball 120 to move upwardly. In other words, as the thickness of the disc 42 is thicker, the position of the central point C of the ball 120 is higher. Thus, the height difference D between the central point C of the ball 120 and the upper edge of the inner hole wall 41 of the disc 42 is fixed, so that the horizontal force F passing through the central point C of the ball 120 provides a torque T with respect to the ball 120 for moving the ball 120 upwardly and clamping the disc 42 downwardly. And, the clamping force for clamping the disc 42 is substantially fixed regardless the thickness of the disc 42.

Referring to FIG. 4C, a comparison diagram without an upper opening is shown. Suppose no opening (that is, the upper opening) is disposed or reserved above the ball 120, there will be no extra vertical space remained for allowing the ball 120 to move upwardly. Under such circumstance, once the thickness of the disc 42 increases and the top surface of the disc 42 is almost coplanar with the central point C of the ball 120, the contact angle will decrease or even become 0 degree, the horizontal force F passing through the central point C of the ball 120 is no more capable of providing a sufficient torque T (the tension arm is too small) to the ball 120. Thus, the ball 120 is incapable of providing a downward clamping force on the disc 42, and the disc 42 rotated at a high speed may be affected by air buoyancy and released from the ball 120.

It can be known from the above descriptions that the balls 120 of the above embodiment can generate a shift between an upper opening S1 and a lower opening S2 of corresponding apertures G according to a thickness of the disc 40 or 42 for creating a height difference D between the central point C of the balls 120 and the upper edge of the inner hole wall 41 of the disc 40 or 42. As long as the central point C of the balls 120 can be adjusted to a height relatively larger than the thickness of the disc 40 or 42, the balls 120 can generate a downward clamping force on the disc 40 or 42 during rotation, hence avoiding the situations as indicated in FIG. 4C that the disc 42 rotated at a high speed is shifted upwardly due to the influence of air buoyancy and released from the ball 120.

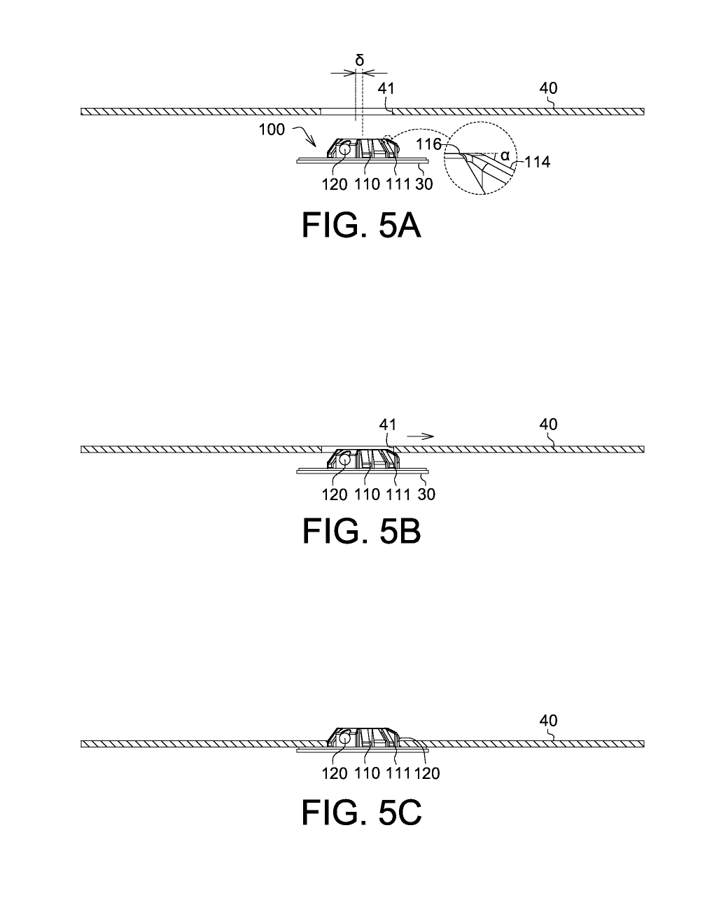

Referring to FIGS. 5A to 5C, schematic diagrams illustrating a disc 40 being shifted and calibrated are shown. As indicated in FIGS. 5A˜5C, during the process of loading the disc 40 to the disc drive, if the center of the disc 40 has a displacement related to the center of the turntable 30, the camber 114 of the ball seat 111 can guide the center of the disc 40 to be aligned with the center of the turntable 30. As indicated in FIG. 5A, the camber 114 of the ball seat 111 has a tilt angle a such as 26 degrees with respect to the surface of the platform 116. The horizontal size and vertical size of the camber 114 can be designed according to a maximum allowance displacement δ of the disc 40. For example, when the disc 40 has a maximum allowance displacement of 2 mm, the horizontal size of the camber 114 is preferably designed larger than 2 mm. As indicated in FIG. 5B, when the disc 40 shifts horizontally during the process of clamping the disc 40, the ball seat 111 will contact the lower edge of the inner hole wall 41 of the disc 40 by the camber 114 which further guides the disc 40 to move horizontally, so that the disc 40 is ready to enter the clamping stage. As indicated in FIG. 5C, after the disc 40 is aligned along with guidance of the camber 114, the center of the turntable 30 is substantially aligned with the center of the disc 40, so that the ball 120 can smoothly clamp the disc 40. That is, through the horizontal force F of the elastic member 130 and the upward shift of the ball 120, the ball 120 contacts the upper edge of the inner hole wall 41 of the disc 40, so that the disc 40 rotated at high speed can be firmly clamped by the ball 120.

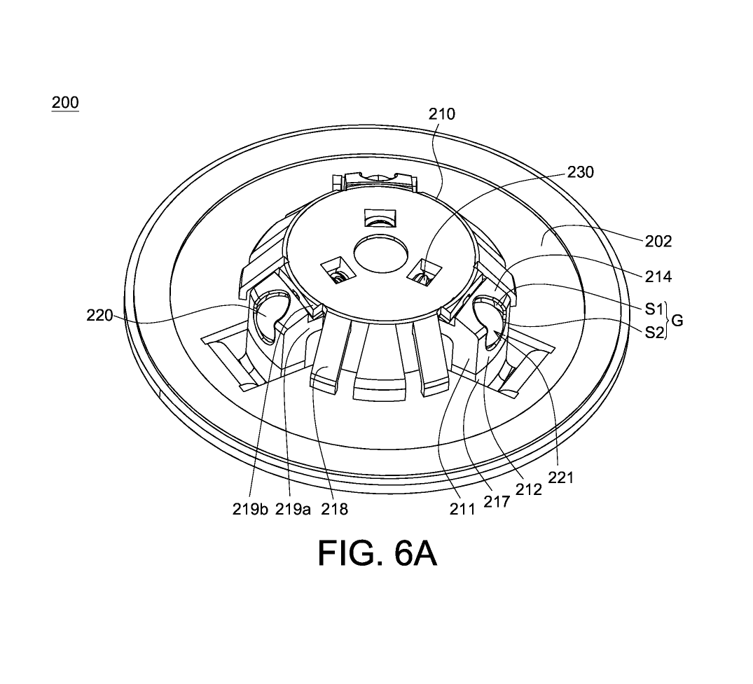

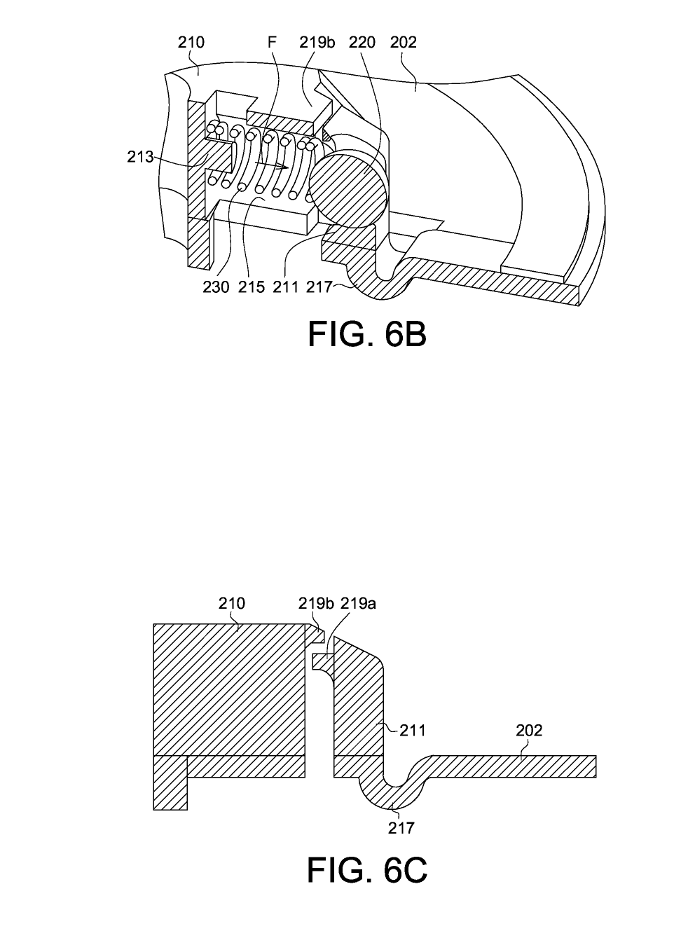

Referring to FIGS. 6A and 6B, a 3D diagram of a disc clamping structure 200 and a partial cross-sectional diagram of the interior of the disc clamping structure 200 according to a second embodiment of the invention are respectively shown. The disc clamping structure 200 comprises a turntable 202, a fixing base 210, several balls 220 and several elastic members 230 corresponding to the balls 220. The disc clamping structure 200 of the present embodiment is different from the first embodiment in that: the turntable 202 comprises several ball seats 211 and several elastic arms 217 connected to the ball seats 211. The ball seats 211, the elastic arms 217 and the turntable 202 can be integrally formed in one piece to reduce assembly tolerance. The dissimilarities are disclosed below.

In the present embodiment of the invention, the ball seats 211 can be movably configured on the turntable 202 and disposed around the fixing base 210 for mounting a disc. That is, the ball seats 211 are extended outwardly through the elastic arms 217 to reduce the gap between each ball seat 211 and the disc 40. When the disc 40 whose inner circle aperture (such as 15.15 mm) larger than that of an ordinary disc (such as 15 mm) and is rotated at a high speed, the gap between the ball seats 211 and the disc 40 may become too large and the balls 220 will be incapable of clamping the disc 40. Hence, in the disc clamping structure 200 of the present embodiment, the fixing base 210 and the ball seats 211 are separated from each other to reduce the gap between each of the ball seats 211 and the disc 40, so that the disc 40 even when rotated at a high speed will be firmly clamped by the balls 220.

Each of ball seats 211 has an accommodation space similar to a ball socket for receiving a ball 220, and a portion of outer surface 221 of the ball 220 is projected from the sidewall of the ball seat 211 through an upper opening S1 and a lower opening S2 of the aperture G to increase flexible space allowing the movement of the ball 220. On the periphery of the fixing base 210 there are several elastic jaws 218 arranged in a circular shape. In addition, based on the design of the upper opening S1 and a lower opening S2 of aperture G the height of the balls 220 in the corresponding ball seats 211 can be adjusted according to a thickness of the disc 40. Also, during the process of loading the disc 40, if the center of the disc 40 has a displacement, the camber 214 of the ball seat 211 can guide the center of the disc 40 to be aligned with the center of the turntable 202. Relevant descriptions are disclosed in FIGS. 3A˜3C and FIG. 4A˜4B, and are not repeated here.

As indicated in FIG. 6B, an elastic member 230 is movably disposed within a corresponding groove 215 of the fixing base 210, one end of elastic member 230 is mounted on a corresponding fixing column 213, the other end of the elastic member 230 is movably connected to a corresponding ball 220 and pushes the corresponding ball 220 with a horizontal force F, so that the corresponding ball 220 is moved outwardly along the direction of the horizontal force F and is preloaded to lean on the aperture G by the elastic member 230.

Referring to FIG. 6C, a cross-sectional diagram illustrating a ball seat 211 and a fixing base 210 of FIG. 6B facing towards each other by two protrusions is shown. As indicated in FIG. 6B, if the movement of the ball seat 211 is not restricted, the ball seat 211 will be pushed outwardly by the elastic member 230 until a balance is reached between a horizontal force F of the elastic member 230 (referring to FIG. 6B) and a restoring force of the elastic arm 217. Hence, when the elastic member 230 of the present embodiment pushes the ball 220 to a fixed point, the ball seat 211 and the fixing base 210 lean on each other by a position restricting element 219a and a stopper 219b respectively, wherein the position restricting element 219a and the stopper 219b are projected from two opposite surfaces of the ball seat 211 and the fixing base 210. That is, the position restricting element 219a of the ball seat 211 is positioned under the stopper 219b of the fixing base 210, and as long as the ball seat 211 is outwardly pushed by the elastic member 230 and the ball 220, the position restricting element 219a will be blocked and stopped by the stopper 219b, so that the ball seat 211 can only be extended outwardly to the fixed point to a limited extent, and cannot be moved further.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A disc clamping structure of an optical disc drive, wherein the optical disc drive has a turntable, the disc clamping structure comprising:
a fixing base disposed on the turntable;
a plurality of ball seats disposed around a periphery of the fixing base, each of the ball seats having an aperture;
a plurality of balls respectively received in corresponding one of the ball seats; and
a plurality of elastic members disposed within the fixing base, wherein the elastic members respectively push corresponding one of the balls for leaning the balls on the apertures;
wherein, the balls are upwardly moved, and the height of the center point of the ball is adjusted according to the thickness of the disc when a disc is clamped on the turntable;
wherein, a portion of the ball is projected from the aperture of the ball seat before clamping a disc.

2. The disc clamping structure according to claim 1, wherein the ball seats are formed on the fixing base.

3. The disc clamping structure according to claim 1, wherein the ball seats are formed on the turntable.

4. The disc clamping structure according to claim 3, wherein the disc clamping structure further comprises a plurality of elastic arms for respectively connecting the ball seats to the turntable, and the ball seat is outwardly moved by the pushing of the elastic member and the ball.

5. The disc clamping structure according to claim 4, wherein each of the ball seats comprises a position restricting element and the fixing base comprises a plurality of stoppers corresponding to the position restricting elements for restricting the outwardly movement of the ball seats.

6. The disc clamping structure according to claim 1, further comprising a plurality of elastic jaws arranged on a periphery of the fixing base, the elastic jaws being arranged in a circular shape and disposed between two of the ball seats.

7. The disc clamping structure according to claim 1, wherein when the disc is clamped on the turntable, a contact angle at which the ball contact the disc maintains at a fixed value regardless the thickness of the disc.

8. The disc clamping structure according to claim 1, wherein the contact angle is defined as an angle formed by a horizontal line and a connection line connecting the central point of the ball to an upper edge of an inner hole wall of the disc.

9. The disc clamping structure according to claim 1, wherein the aperture comprises an upper opening and a lower opening.

10. The disc clamping structure according to claim 1, wherein the aperture is gourd-shaped.
